(19) United States
(12) Patent Application Publication
(10) Pub. No.: US 2019/0311414 A1
(43) Pub. Date: Oct. 10, 2019

(54) SEARCH DEVICE AND SEARCH METHOD

(71) Applicant: FUJITSU LIMITED, Kawasaki-shi (JP)

(72) Inventor: Hiroshi Otsuka, Kawasaki (JP)

(73) Assignee: FUJITSU LIMITED, Kawasaki-shi (JP)

(21) Appl. No.: 16/368,923

(22) Filed: Mar. 29, 2019

(30) Foreign Application Priority Data
Apr. 6, 2018 (JP) 2018-074233

(51) Int. Cl. G06Q 30/06; G06F 16/245; G06F 16/248

(52) U.S. Cl. CPC G06Q 30/0625; G06F 16/248; G06F 16/245

(57) ABSTRACT

A search device includes a memory, and a processor coupled to the memory and the processor configured to calculate a plurality of evaluation values relating to a plurality of items respectively, in accordance with differences between a plurality of search conditions including the plurality of items, in response to receiving a new search condition, perform a search process based on both the new search condition and the calculated plurality of evaluation values, and output a result of the search process.

### CROSS-REFERENCE TO RELATED APPLICATION

This application is based upon and claims the benefit of priority of the prior Japanese Patent Application No. 2018-74233, filed on Apr. 6, 2018, the entire contents of which are incorporated herein by reference.

### FIELD

The embodiments discussed herein are related to a search technology.

### BACKGROUND

In recent years, digital arenas have spread, the digital arenas being places where various participants make deals with each other as users or providers of products or services. FIG. 22 is a diagram of assistance in explaining a digital arena. As illustrated in FIG. 22, a search device providing the digital arena performs matching between users and providers of products or services. For example, the search device finds a combination satisfying a condition input by a user, and notifies a response to the user.

FIG. 23 is a diagram illustrating an example of the digital arena. In FIG. 23, the search device provides a place where transportation service is traded. A user for the search device is a shipper, and a provider for the search device is a carrier. When the user who desires to perform refrigerated transportation of 40 items in Matsue City inputs “Matsue City, 40 items, refrigeration” as a condition, for example, the search device outputs “8/1, AM, Matsue City, 40 items, X transport” as a matching result. For example, the search device notifies the user of a response indicating that X transport performs refrigerated transportation of 40 items in Matsue City on the morning of 8/1.

As a conventional technology, there is a technology of identifying an attribute item regarded as important by a user in selecting a trade object. This technology extracts a trade object not selected by the user among trade objects whose information is viewed within a preset time of a date and time of viewing information about a trade object selected by the user. An attribute item regarded as important by the user is identified based on an attribute value whose setting differs between the trade object selected by the user and the trade object not selected by the user.

There is a technology of providing another information processing device via a network with integrated interest data as information recommending contents to a user, the integrated interest data being obtained by performing given weighting of values indicating degrees of importance of interest data indicating user interests, the interest data being transmitted from a plurality of other information processing devices. According to this technology, contents close to interests of a user may be recommended.

There is a content search device that orders contents based on contents information, user information, and access information, and searches for information matching preferences of a user. The contents information is information obtained by digitizing attributes of individual contents. The user information is information obtained by digitizing the preferences of the user in regard to contents by attribute. The access information is information obtained by digitizing attributes of search information each time the user accesses a search information system.

Related technologies are disclosed in Japanese Laid-open Patent Publication No. 2013-114568, Japanese Laid-open Patent Publication No. 2004-355109, and Japanese Laid-open Patent Publication No. 2009-245382, for example.

### SUMMARY

According to an aspect of the embodiments, a search device includes a memory, and a processor coupled to the memory and the processor configured to calculate a plurality of evaluation values relating to a plurality of items respectively, in accordance with differences between a plurality of search conditions including the plurality of items, in response to receiving a new search condition, perform a search process based on both the new search condition and the calculated plurality of evaluation values, and output a result of the search process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram of assistance in explaining a matching history;

FIG. 2 is a diagram of assistance in explaining participant evaluation by a search device according to an embodiment;

FIG. 3 is a diagram illustrating an example of outputting a search result based on an evaluation value set;

FIG. 4 is a diagram illustrating an example of outputting a result of making a search with a condition relaxed from an evaluation axis having a low evaluation value;

FIG. 5 is a diagram illustrating a functional configuration of the search device according to the embodiment;

FIG. 6 is a diagram illustrating an example of a matching history;

FIG. 7 is a diagram illustrating an example of service classification data;

FIG. 8 is a diagram illustrating a matching history including service classification names;

FIG. 9 is a diagram illustrating an example of evaluation axis estimation data;

FIG. 10 is a diagram illustrating an example of evaluation axis data;

FIG. 11 is a diagram illustrating an example of a change score;

FIG. 12 is a diagram illustrating another example of a change score;

FIG. 13 is a diagram illustrating an example of an evaluation value calculated from a change score;

FIG. 14 is a diagram illustrating another example of an evaluation value calculated from a change score;

FIG. 15 is a flowchart illustrating a flow of processing by an evaluation axis learning section;

FIG. 16 is a flowchart illustrating a flow of processing by an evaluation estimating section;

FIG. 17 is a flowchart illustrating a flow of processing by a service classifying section;

FIG. 18 is a flowchart illustrating a flow of processing by an evaluation axis estimating section;

FIG. 19 is a flowchart illustrating a flow of processing by a learning section;

FIG. 20 is a flowchart illustrating a flow of processing by an evaluation estimating section;

FIG. 21 is a diagram illustrating a hardware configuration of a computer that executes a search program according to an embodiment;

FIG. 22 is a diagram of assistance in explaining a digital arena;

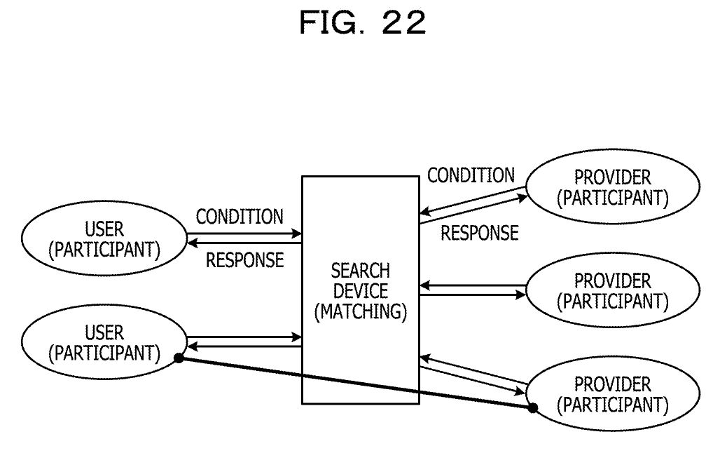

FIG. 23 is a diagram illustrating an example of a digital arena; and

FIG. 24 is a diagram illustrating an example of evaluation axes.

### DESCRIPTION OF EMBODIMENT

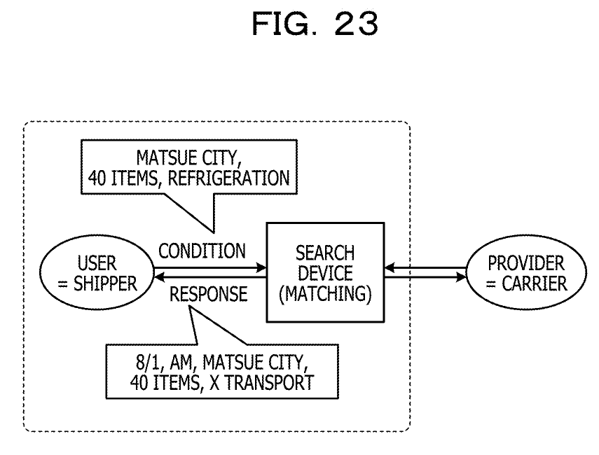

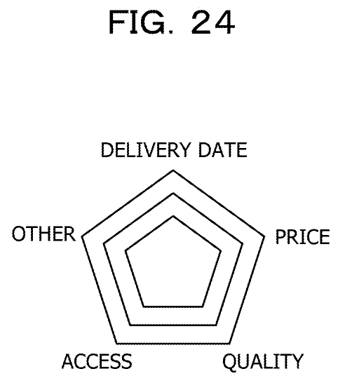

In the digital arena, an example of which is illustrated in FIG. 23, participants gather in an open manner, and the participants are fluid, so that the participants do not know each other. The participants in the digital arena have various values. Hence, in the digital arena, it is difficult to identify an evaluation axis regarded as important by each of the participants. The evaluation axis is an item included in a search condition. FIG. 24 is a diagram illustrating an example of evaluation axes. In the example of FIG. 24, delivery date, price, quality, access, and other are the evaluation axes. With the conventional technology, a search device providing the digital arena has a difficulty in identifying the evaluation axis regarded as important by each of the participants, and therefore has a difficulty in making a search based on the evaluation axis regarded as important by the participant.

Embodiments of a search program, a search method, and a search device disclosed in the present application will hereinafter be described in detail with reference to the drawings. It is to be noted that the embodiments do not limit the disclosed technology.

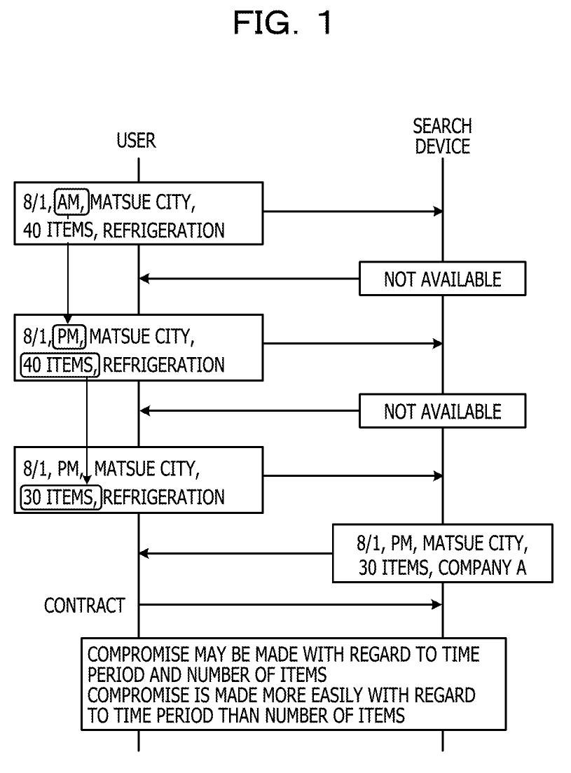

Description will first be made of a matching history used for evaluation axis estimation by a search device according to an embodiment. FIG. 1 is a diagram of assistance in explaining a matching history. In FIG. 1, a user inputs “8/1, AM, Matsue City, 40 items, refrigeration” as a condition. Because there is no provider satisfying the condition, the search device according to the embodiment makes a response indicating “not available.”

The user changes the time period “AM” in the condition to “PM,” and makes a search. Because there is no provider satisfying the condition, the search device according to the embodiment makes a response indicating “not available.” The user changes the number of items, For example, “40 items” in the condition to “30 items,” and makes a search. The search device according to the embodiment finds a provider matching the condition, and makes a response indicating “8/1, PM, Matsue City, 30 items, company A.”

In the present example, the time period is first relaxed, and next the number of items is relaxed. Hence, the user considers that a compromise may be made with regard to the time period and the number of items, and a compromise is made more easily with regard to the time period than the number of items. Thus, an evaluation axis regarded as important by the user appears in changes in the condition input by the user. Accordingly, the search device according to the embodiment estimates the evaluation axis regarded as important by the user based on the evaluation axes relaxed by the user in the matching history and the order thereof. The search device according to the embodiment improves evaluation axis estimation accuracy by learning a plurality of matching histories.

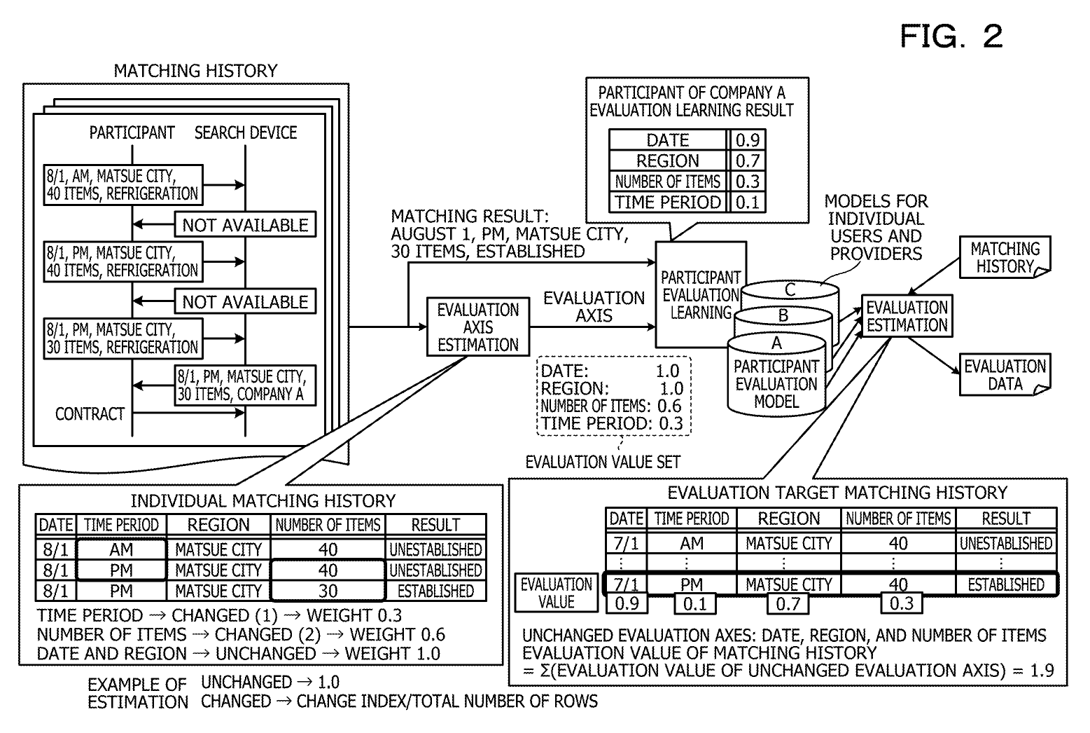

FIG. 2 is a diagram of assistance in explaining participant evaluation by the search device according to the embodiment. The participant evaluation is to calculate, for each evaluation axis, an evaluation value indicating a degree to which a participant regards the evaluation axis as important. As illustrated in FIG. 2, the search device according to the embodiment performs the evaluation axis estimation based on a matching history of company A, and calculates the weight of each evaluation axis.

In the matching history of company A, the time period is first relaxed. The search device according to the embodiment therefore sets the weight of the time period at 0.3. The weight is obtained by dividing a change index by a total number of rows. Here, the change index is obtained by subtracting one from the number of a row in which an evaluation axis is relaxed in the matching history. The total number of rows is the number of rows in the whole of the matching history. The weight of the time period is ⅓≈0.3. The number of items is relaxed second, and therefore the search device according to the embodiment sets the weight of the number of items at ⅔≈0.6. The date and the region are not relaxed, and therefore the search device according to the embodiment sets the weights of the date and the region at 1.0.

The search device according to the embodiment sets the calculated weights as the evaluation values of the evaluation axes, and sets a group of the evaluation values of the plurality of evaluation axes as an evaluation value set. In this case, (date: 1.0, region: 1.0, number of items: 0.6, time period: 0.3) is an evaluation value set.

The search device according to the embodiment creates a plurality of evaluation value sets using a plurality of matching histories, and performs participant evaluation learning using the created plurality of evaluation value sets. In FIG. 2, as a result of performing the participant evaluation learning for company A, the evaluation value of the date is 0.9, the evaluation value of the region is 0.7, the evaluation value of the number of items is 0.3, and the evaluation value of the time period is 0.1. For example, an evaluation value set (date: 0.9, region: 0.7, number of items: 0.3, time period: 0.1) is obtained.

The search device according to the embodiment stores a result of performing the participant evaluation learning for company A as a participant evaluation model of company A. Similarly, the search device according to the embodiment stores a result of performing the participant evaluation learning for company B as a participant evaluation model of company B, and stores a result of performing the participant evaluation learning for company C as a participant evaluation model of company C.

In FIG. 2, an item corresponding to an item value “refrigeration” is a type of delivery. However, the type represents a service classification, and is used for classification of learning. No evaluation value is therefore calculated for the type. For example, the search device according to the embodiment performs learning for each service classification. In addition, “unestablished” as a result indicates that there is no provider matching the condition, and “established” as a result indicates that a provider matching the condition is retrieved.

Thus, the search device according to the embodiment identifies an evaluation axis regarded as important by a user by using a matching history, and therefore enables the user to save the trouble of inputting the evaluation axis regarded as important by the user.

The search device according to the embodiment performs evaluation estimation for a new matching history based on the evaluation value set obtained by the learning, and outputs evaluation data. The evaluation estimation is to estimate evaluation of the user for a final search result included in the matching history.

In FIG. 2, in an evaluation target matching history, the time period is changed, and the date, the region, and the number of items are not changed. At this time, the search device according to the embodiment estimates the evaluation of the user for the matching history by adding the evaluation values of the unchanged evaluation axes. The evaluation values of the date, the region, and the number of items are “0.9,” “0.7,” and “0.3,” respectively. Therefore, the evaluation value of the evaluation target matching history is estimated to be “1.9,” and “1.9” is output as the evaluation data.

Thus, the search device according to the embodiment may estimate the evaluation of the user for the evaluation target matching history by adding the evaluation values of the unchanged evaluation axes.

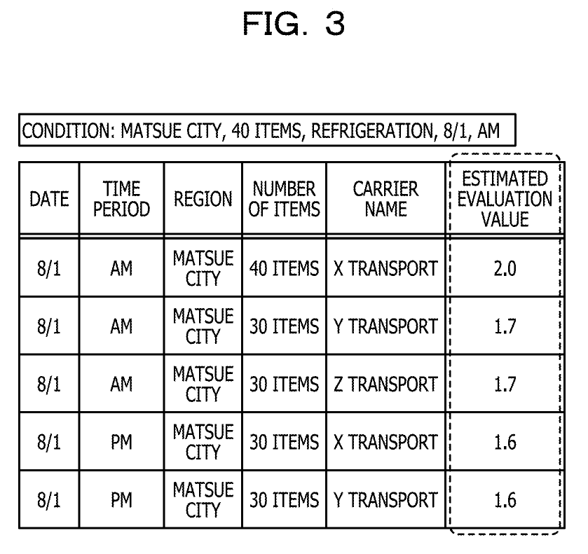

The search device according to the embodiment may also output a search result based on the evaluation value set. FIG. 3 is a diagram illustrating an example of outputting a search result based on an evaluation value set. In FIG. 3, the search device according to the embodiment outputs a given number of (five) search results in decreasing order of estimated evaluation values. An estimated evaluation value is a value obtained by adding the evaluation values of evaluation axes not changed in the search result among the evaluation axes included in the condition. The estimated evaluation values are not displayed as a search result.

As illustrated in FIG. 3, when a user inputs a condition “Matsue City, 40 items, refrigeration, 8/1, AM,” evaluation axes not changed from the condition in “8/1, AM, Matsue City, 40 items, X transport” are the date, the time period, the region, and the number of items. Hence, the estimated evaluation value is “0.9”+“0.1”+“0.7”+“0.3”=“2.0.”

Thus, the search device according to the embodiment may increase choices for the user by outputting a given number of search results in decreasing order of estimated evaluation values.

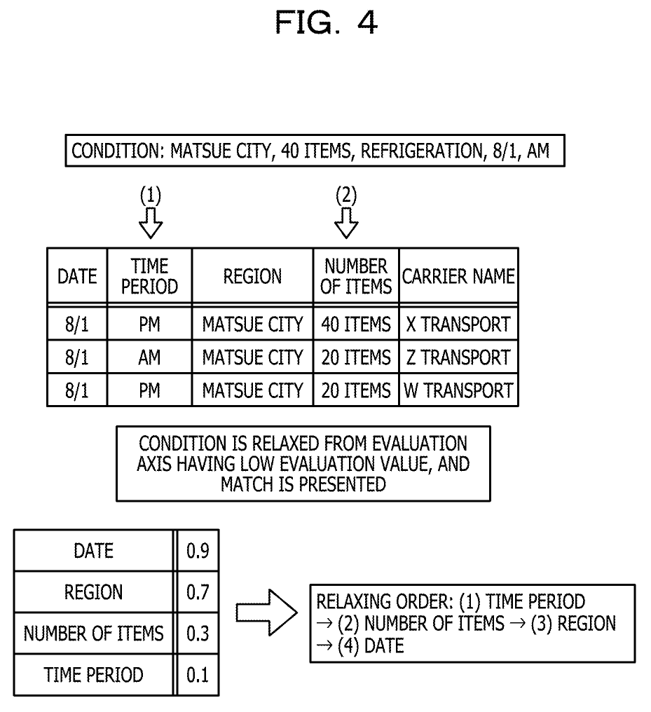

The search device according to the embodiment may also output a result of making a search with a condition relaxed from an evaluation axis having a low evaluation value in a case where there is no product or service perfectly matching the condition. FIG. 4 is a diagram illustrating an example of outputting a result of making a search with a condition relaxed from an evaluation axis having a low evaluation value.

As illustrated in FIG. 4, when the user inputs a condition “Matsue City, 40 items, refrigeration, 8/1, AM,” and there is no transportation service perfectly matching the condition, the search device according to the embodiment relaxes the “time period” as an evaluation axis having a smallest evaluation value. As a result, the search device according to the embodiment outputs “8/1, PM, Matsue City, 40 items, Y transport.” The search device according to the embodiment relaxes the number of items as an evaluation axis having a next smallest evaluation value, and outputs “8/1, AM, Matsue City, 20 items, Z express” and “8/1, PM, Matsue City, 20 items, W transport.”

Thus, the search device according to the embodiment outputs information about a provider after relaxing a condition from an evaluation axis having a low evaluation value. The search device according to the embodiment may therefore output information about a product or a service estimated to be acceptable by the user in a case where there is no product or service perfectly matching the condition.

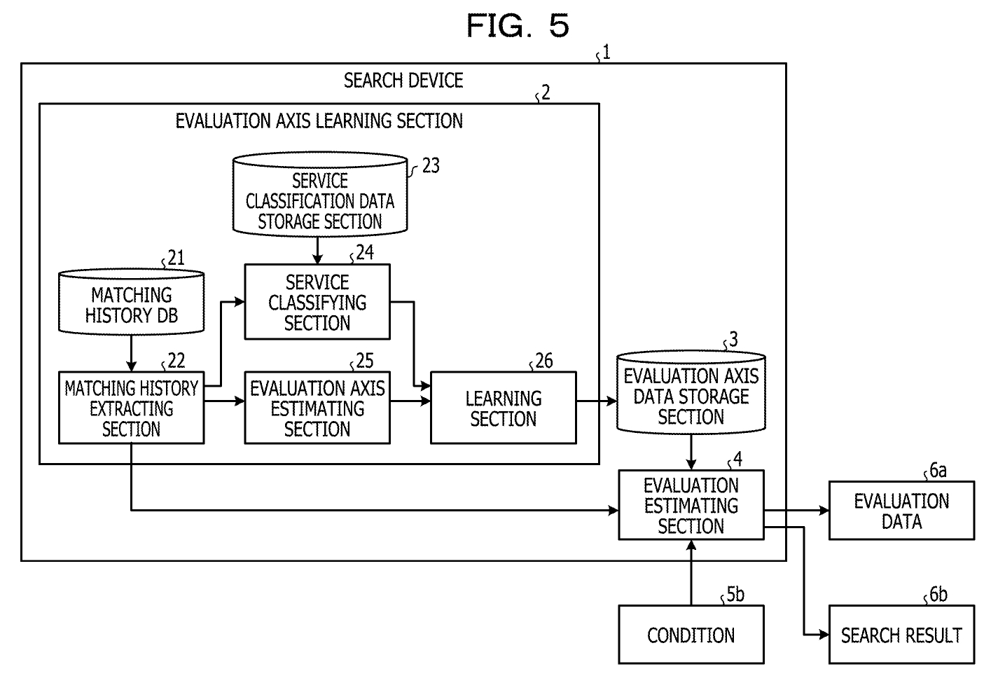

Description will next be made of a functional configuration of the search device according to the embodiment. FIG. 5 is a diagram illustrating a functional configuration of the search device according to the embodiment. As illustrated in FIG. 5, the search device 1 according to the embodiment includes an evaluation axis learning section 2, an evaluation axis data storage section 3, and an evaluation estimating section 4.

The evaluation axis learning section 2 creates a participant evaluation model by learning matching histories, and stores the participant evaluation model as evaluation axis data in the evaluation axis data storage section 3. The evaluation axis data storage section 3 stores the evaluation axis data. The evaluation estimating section 4 receives a matching history other than those used for the learning from the evaluation axis learning section 2, and displays evaluation data 6a corresponding to the matching history on a terminal device of the user. The matching history other than those used for the learning may be input by the user. The evaluation estimating section 4 receives a search condition 5b, and displays a search result 6b on the terminal device of the user.

The evaluation axis learning section 2 includes a matching history DB 21, a matching history extracting section 22, a service classification data storage section 23, a service classifying section 24, an evaluation axis estimating section 25, and a learning section 26.

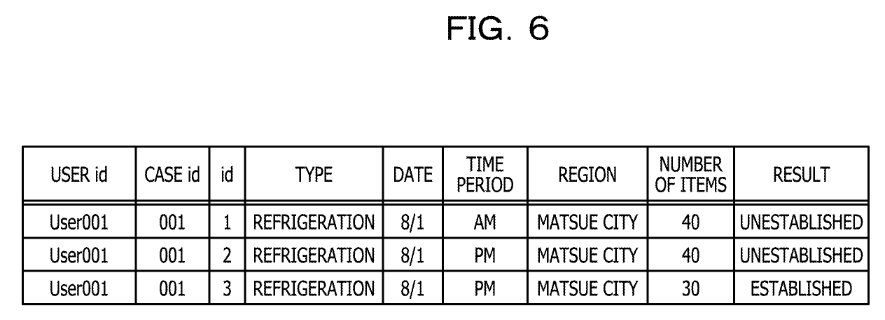

The matching history DB 21 is a database storing a plurality of matching histories. FIG. 6 is a diagram illustrating an example of a matching history. As illustrated in FIG. 6, a matching history has a plurality of rows, and each row includes a user id, a case id, an id, a type, a date, a time period, a region, a number of items, and a result.

Each row is information about one search. The user id is an identifier identifying a user. The case id is an identifier identifying the matching history. The id is an identifier identifying the row. The type is a service classification. Service classifications include “room temperature,” “frozen,” and “refrigeration.” The date, the time period, the region, and the number of items are items included in a condition. The result indicates that matching is “established” or “unestablished.”

For example, the matching history identified by “001” for a user identified by “User001” indicates that a search was made with “Matsue City, 40 items, refrigeration, 8/1, AM” as a condition, but matching was “unestablished.” The condition was changed to “Matsue City, 40 items, refrigeration, 8/1, PM” and a search was made, but matching was “unestablished.” Matching was “established” as a result of changing the condition to “Matsue City, 30 items, refrigeration, 8/1, PM” and making a search.

The matching history extracting section 22 extracts a matching history from the matching history DB 21, and passes the matching history to the service classifying section 24 and the evaluation axis estimating section 25. The matching history extracting section 22 extracts an evaluation target matching history from the matching history DB 21, and passes the evaluation target matching history to the evaluation estimating section 4.

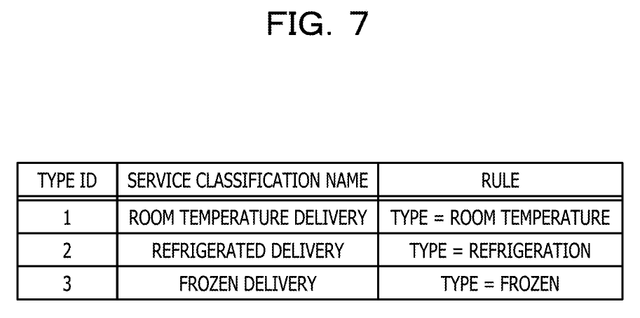

The service classification data storage section 23 stores service classification data, which is data on service classifications. FIG. 7 is a diagram illustrating an example of the service classification data. As illustrated in FIG. 7, the service classification data is data associating type ids, service classification names, and rules.

A type id is an identifier identifying a type. A service classification name is the name of a service classification. The service classification names include “room temperature delivery,” “refrigerated delivery,” and “frozen delivery.” The rules associate the service classification names with the types. The service classification name of a type “room temperature” is “room temperature delivery.” The service classification name of a type “refrigeration” is “refrigerated delivery.” The service classification name of a type “frozen” is “frozen delivery.”

The service classifying section 24 classifies services of matching histories. For example, the service classifying section 24 identifies a service classification name corresponding to a type included in a matching history based on the service classification data storage section 23, and passes the service classification name to the learning section 26.

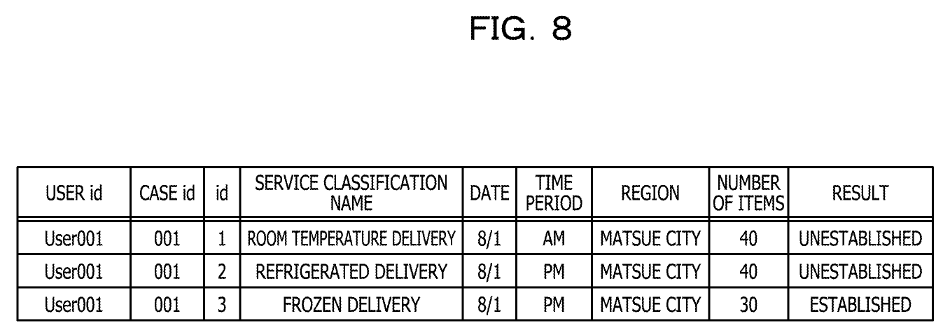

The service classification name may be included in the matching history in place of the type. FIG. 8 is a diagram illustrating a matching history including service classification names. As illustrated in FIG. 8, the service classification names are included in the matching history in place of types. When matching histories include service classification names in place of types, the service classification data storage section 23 and the service classifying section 24 become unnecessary.

However, in order to include a service classification name in a matching history, the user needs to precisely specify “room temperature delivery,” “refrigerated delivery,” or “frozen delivery” in a condition. However, the user may simply specify “refrigeration” or the like in the condition. Accordingly, the service classifying section 24 converts the service classification names into the types according to the rules of the service classification data. Terms that may be used by the user for service classifications in conditions may be increased by increasing the rules of the service classification data.

The evaluation axis estimating section 25 calculates the evaluation value of each evaluation axis of the matching history passed from the matching history extracting section 22, and thereby creates evaluation axis estimation data. The evaluation axis estimating section 25 sets the evaluation value of an evaluation axis not changed in the matching history at “1.0.” For an evaluation axis changed in the matching history, letting J be the number of rows in the matching history, and letting a value obtained by subtracting one from the row number of a row in which the value of the evaluation axis is changed for a first time be the change index jc, the evaluation axis estimating section 25 sets jc/J as the evaluation value of the evaluation axis.

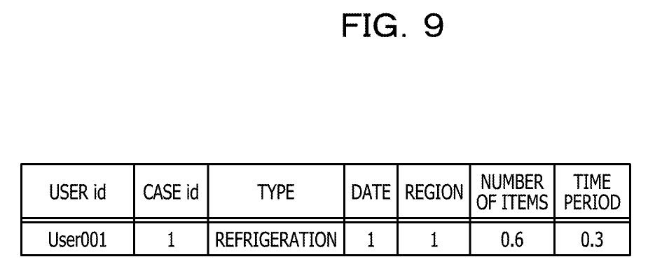

FIG. 9 is a diagram illustrating an example of the evaluation axis estimation data. As illustrated in FIG. 9, the evaluation axis estimation data includes a user id, a case id, a type, and the evaluation values of a date, a region, a number of items, and a time period. The date, the region, the number of items, and the time period are arranged in decreasing order of the evaluation values. In FIG. 9, from the matching history identified by “1” for the user identified by “User001,” with regard to “refrigeration,” the evaluation values of the date, the region, the number of items, and the time period are estimated to be “1,” “1,” “0.6,” and “0.3,” respectively. The evaluation axis estimation data includes the evaluation value set.

The learning section 26 receives the evaluation axis estimation data from the evaluation axis estimating section 25, and receives the service classifications from the service classifying section 24. The learning section 26 learns a plurality of pieces of evaluation axis estimation data for each service classification, creates evaluation axis data for each service classification, and stores the evaluation axis data in the evaluation axis data storage section 3. The learning section 26 performs the creation of the evaluation axis data for each user. Details of learning by the learning section 26 will be described later.

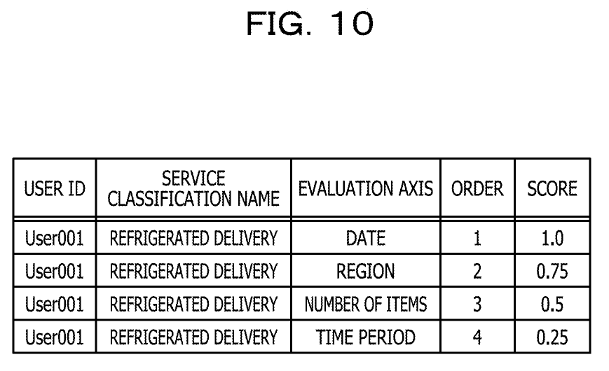

FIG. 10 is a diagram illustrating an example of the evaluation axis data. As illustrated in FIG. 10, the evaluation axis data includes a user id, a service classification name, an evaluation axis, order, and a score. The order is decreasing order of evaluation values of corresponding evaluation axes, and is order regarded as important by the user when the user uses service. The score is the evaluation value of the corresponding evaluation axis.

For example, with regard to “refrigerated delivery” for the user identified by “User001,” the evaluation value of the date is “1.0,” which is a largest evaluation value, and therefore the date is “1” in the order. For example, the user regards the “date” as most important when performing “refrigerated delivery.” The evaluation axis data includes an evaluation value set.

While the evaluation axis estimating section 25 calculates the evaluation value of an evaluation axis based on presence or absence of a change and earliness (row number in the matching history) of the change made, the evaluation axis estimating section 25 may calculate the evaluation value by other methods. Accordingly, description will be made of variations in the method of calculating the evaluation value.

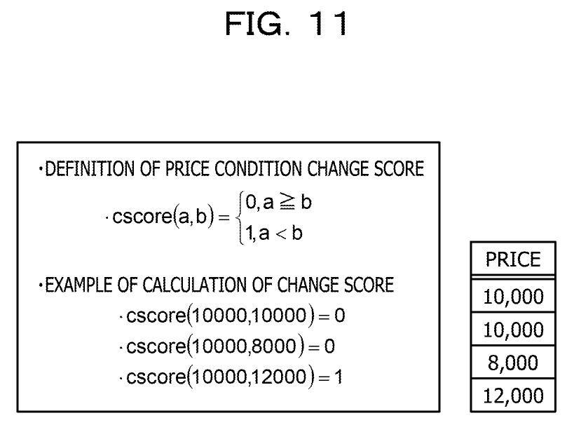

A change score used for calculating the evaluation value will be described first. The change score is used when the evaluation value is calculated based on a manner of changing rather than presence or absence of a change. FIG. 11 is a diagram illustrating an example of the change score. In FIG. 11, the evaluation axis is price. In FIG. 11, in a case where the user changes price from a to b in a condition, Change Score cscore(a, b)=0 when a≥b, and cscore(a, b)=1 when a<b.

For example, cscore(10000, 10000)=0, cscore(10000, 8000)=0, and cscore(10000, 12000)=1. For example, the change score is increased when the price is raised.

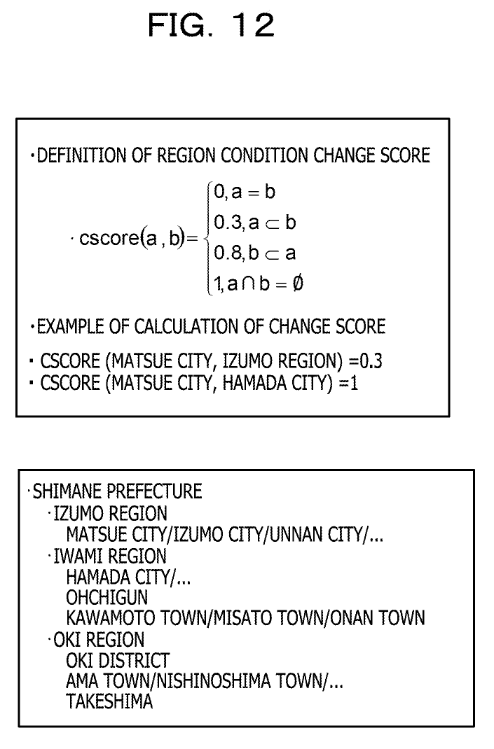

FIG. 12 is a diagram illustrating another example of the change score. In FIG. 12, the evaluation axis is region. In FIG. 12, in a case where the user changes a region in a condition from a to b, cscore(a, b)=0 when a=b, cscore(a, b)=0.3 when a⊂b, cscore(a, b)=0.8 when b⊂a, and cscore(a, b)=1 when a∩b=φ.

For example, because Matsue City is included in the Izumo region, cscore(Matsue City, Izumo region)=0.3, and because Matsue City and Hamada City are entirely different places, cscore(Matsue City, Hamada City)=1. For example, the change score is increased when the region is changed to an entirely different place.

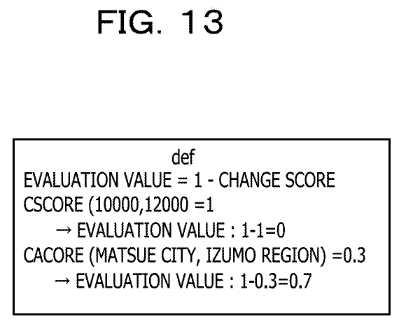

FIG. 13 is a diagram illustrating an example of an evaluation value calculated from the change score. In FIG. 13, an evaluation value is defined by 1−Change Score. For example, because cscore(10000, 12000)=1, the evaluation value of the price is zero when the price is raised. It is estimated that the price is not regarded as important when a search is made after the price is raised. Because cscore(Matsue City, Izumo region)=0.3, the evaluation value of the region is 0.7 when the region is expanded.

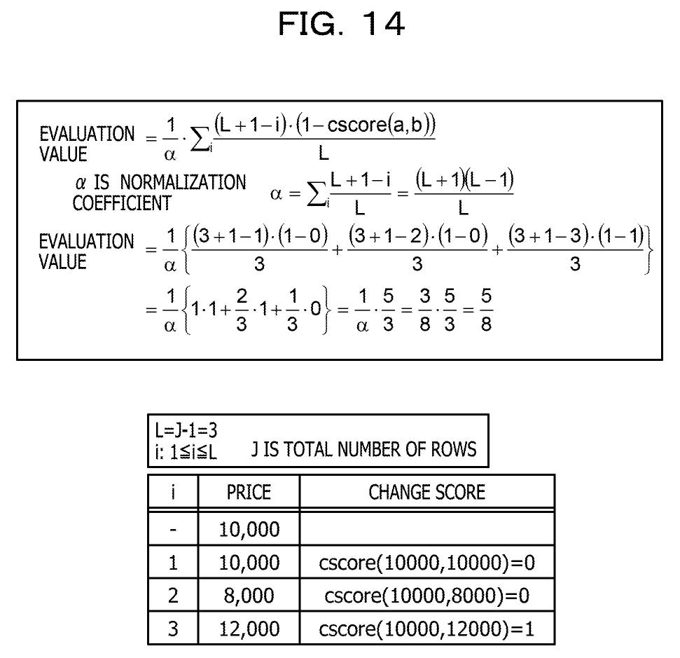

FIG. 14 is a diagram illustrating another example of an evaluation value calculated from the change score. In FIG. 14,

$$\begin{matrix}[ Expression 1 ] & \\ Evaluation Value = \frac{1}{α} \cdot {\sum }_{i} \frac{( L + 1 - i ) \cdot ( 1 - cscore ( a , b ) )}{L} & ( 1 )\end{matrix}$$

Where letting J be a total number of rows in the matching history, L is L=J−1, i is the condition change index, and 1≤i≤L. α is a normalization coefficient, and is

$$\begin{matrix}[ Expression 2 ] & \\ α = {\sum }_{i} \frac{L + 1 - i}{L} = \frac{( L + 1 ) \cdot ( L - 1 )}{L} & ( 2 )\end{matrix}$$

For example, in a case where cscore(10000, 10000)=0 when i=1, cscore(10000, 8000)=0 when i=2, and cscore(10000, 12000)=1 when i=3, the evaluation value is

$$\begin{matrix}[ Expression 3 ] & \\ Evaluation Value = \frac{1}{α} \{ \frac{( 3 + 1 - 1 ) \cdot ( 1 - 0 )}{3} + \frac{( 3 + 1 - 2 ) \cdot ( 1 - 0 )}{3} + \frac{( 3 + 1 - 3 ) \cdot ( 1 - 1 )}{3} \} = \frac{1}{α} \{ 1 \cdot 1 + \frac{2}{3} \cdot 1 + \frac{1}{3} \cdot 0 \} = \frac{1}{α} \cdot \frac{5}{3} = \frac{3}{8} \cdot \frac{5}{3} = \frac{5}{8} & ( 3 )\end{matrix}$$

When the evaluation value is defined by Equation (1) as described above, the magnitude of the evaluation value is decreased in order of a case of tightening the evaluation axis early, a case of tightening the evaluation axis late, a case of relaxing the evaluation axis late, and a case of relaxing the evaluation axis early.

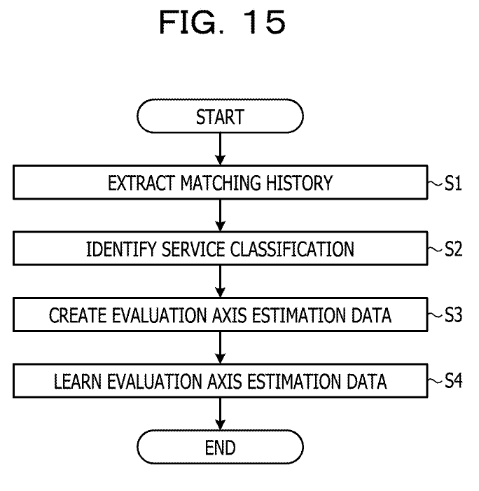

Flows of processing by the search device 1 will next be described with reference to FIGS. 15 to 20. FIG. 15 is a flowchart illustrating a flow of processing by the evaluation axis learning section 2. As illustrated in FIG. 15, the evaluation axis learning section 2 extracts a matching history from the matching history DB 21 (step S1), and identifies the service classification of the matching history (step S2).

The evaluation axis learning section 2 calculates the evaluation values of evaluation axes in the matching history, and thereby creates evaluation axis estimation data (step S3). The evaluation axis learning section 2 learns one or more pieces of evaluation axis estimation data for each service classification (step S4), selects one piece of evaluation axis estimation data from the one or more pieces of evaluation axis estimation data, and creates evaluation axis data.

The evaluation axis learning section 2 thus creates the evaluation axis data. The evaluation estimating section 4 may therefore output evaluation data 6a and a search result 6b by using the evaluation axis data.

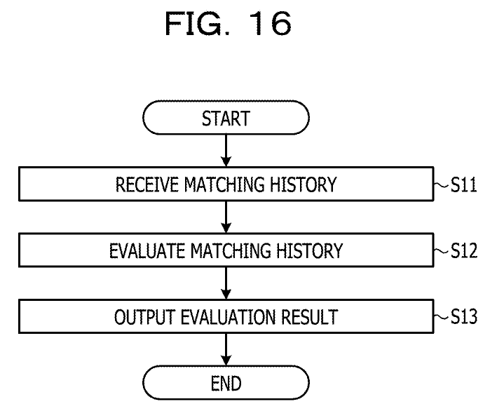

FIG. 16 is a flowchart illustrating a flow of processing by the evaluation estimating section 4. FIG. 16 represents a case where the evaluation estimating section 4 evaluates a matching history, and outputs evaluation data 6a. As illustrated in FIG. 16, the evaluation estimating section 4 receives a matching history (step S11), and evaluates the matching history (step S12). The evaluation estimating section 4 outputs an evaluation result (step S13).

The evaluation estimating section 4 may thus estimate an evaluation of the user for a matching result by evaluating the matching history using the evaluation axis data.

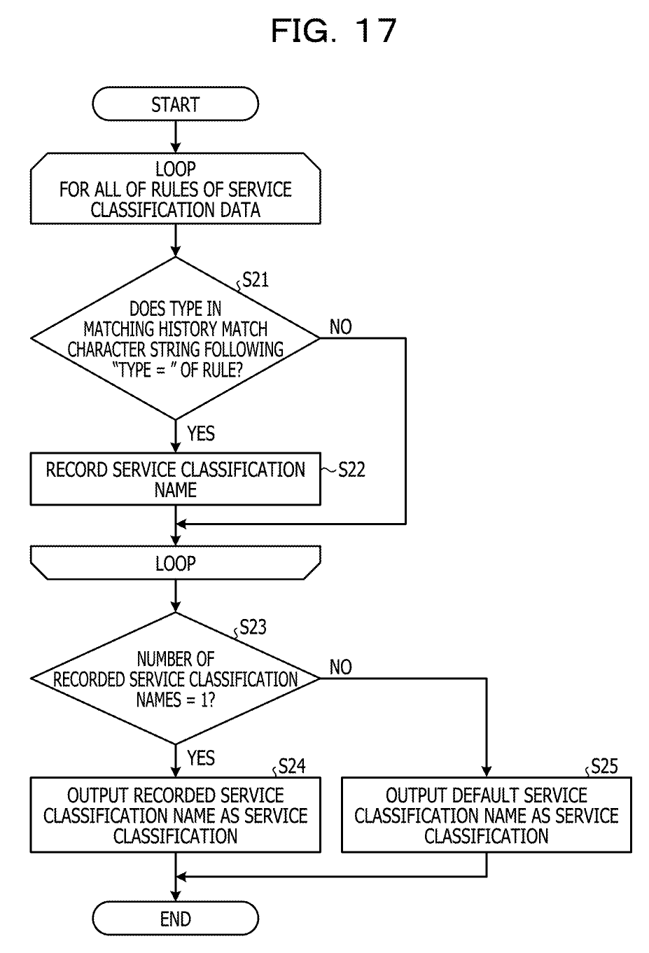

FIG. 17 is a flowchart illustrating a flow of processing by the service classifying section 24. FIG. 17 illustrates processing performed for one matching history. As illustrated in FIG. 17, the service classifying section 24 performs the following processing of step S21 and step S22 for all of the rules of the service classification data. For example, the service classifying section 24 determines for each rule whether or not a type in the matching history matches a character string following “type=” of the rule (step S21). When the type in the matching history matches, the service classifying section 24 records the service classification name corresponding to the matching rule (step S22).

The service classifying section 24 determines whether or not the number of recorded service classification names is one (step S23). When the number of recorded service classification names is one, the service classifying section 24 outputs the recorded service classification name as a service classification (step S24). Incidentally, the case where the number of recorded service classification names is one is a case where the service classification corresponding to the type in the matching history is identified. When the number of recorded service classification names is not one, on the other hand, the service classifying section 24 outputs a default service classification name as a service classification (step S25).

The service classifying section 24 thus identifies the service classification corresponding to the type in the matching history. The learning section 26 may therefore learn the evaluation axis estimation data for each service classification.

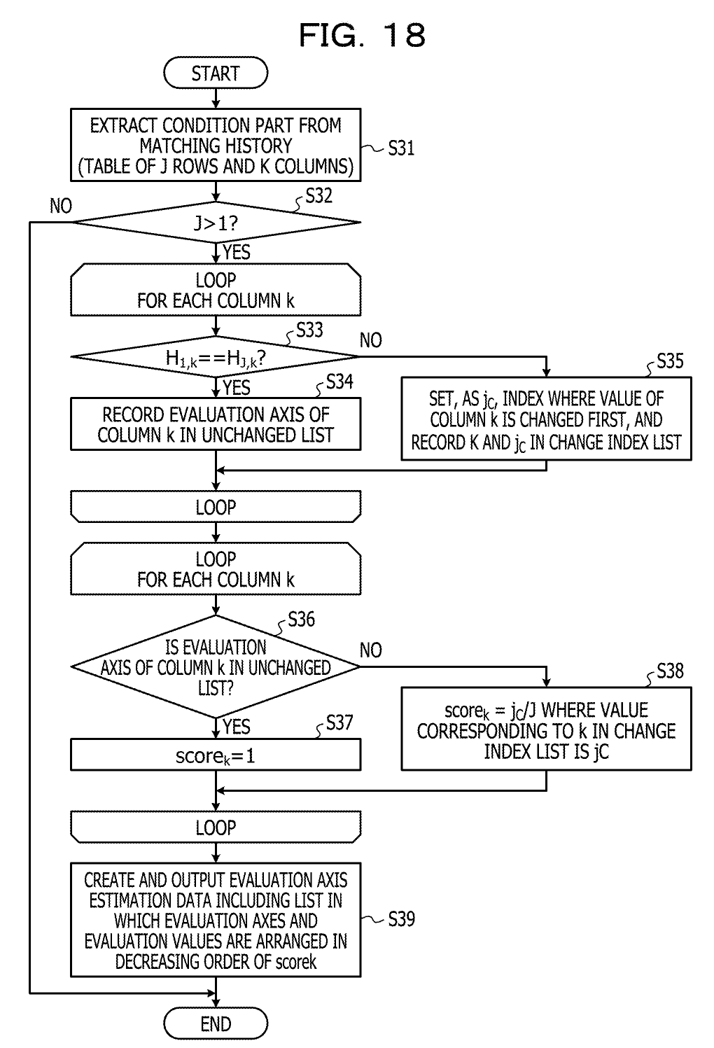

FIG. 18 is a flowchart illustrating a flow of processing by the evaluation axis estimating section 25. FIG. 18 illustrates processing performed for one matching history. As illustrated in FIG. 18, the evaluation axis estimating section 25 extracts a condition part from the matching history (step S31). The extracted condition part is a table H of J rows and K columns. J is the number of rows in the matching history, and K is the number of evaluation axes.

The evaluation axis estimating section 25 determines whether or not J is larger than one (step S32). When J is not larger than one, a service matching the condition is found in a first search, and therefore the processing is ended without estimating the evaluation values of evaluation axes.

When J is larger than one, on the other hand, the evaluation axis estimating section 25 performs the following processing of steps S33 to S35 for each row k (1≤k≤K). For example, the evaluation axis estimating section 25 determines for each row k whether or not H_{1, k} and H_{J, k} are substantially equal to each other (step S33). When H_{1, k} and H_{J, k} are substantially equal to each other, the column k is not changed. When H_{1, k} and H_{J, k} are not substantially equal to each other, the column k is changed.

When H_{1, k} and H_{J, k} are substantially equal to each other, the evaluation axis estimating section 25 records the evaluation axis of the column k in an unchanged list (step S34). When H_{1, k} and H_{J, k} are not substantially equal to each other, on the other hand, the evaluation axis estimating section 25 sets, as j_{c}, an index (Row Number−1) where the value of the column k is changed first, and records k and j_{c} in a change index list (step S35).

The evaluation axis estimating section 25 performs the following processing of steps S36 to S38 for each column k. For example, the evaluation axis estimating section 25 determines for each column k whether or not the evaluation axis of the column k is in the unchanged list (step S36). When the evaluation axis of the column k is in the unchanged list, the evaluation axis estimating section 25 sets scoreₖ at one (step S37). Scoreₖ is the evaluation value of the evaluation axis of the column k. When the evaluation axis of the column k is not in the unchanged list, on the other hand, the evaluation axis estimating section 25 sets scoreₖ at j_{c}/J (step S38).

The evaluation axis estimating section 25 creates and outputs evaluation axis estimation data including a list in which evaluation axes and evaluation values are arranged in decreasing order of scoreₖ (step S39).

The evaluation axis estimating section 25 thus creates the evaluation axis estimation data from the matching history. The learning section 26 may therefore learn the evaluation axis estimation data.

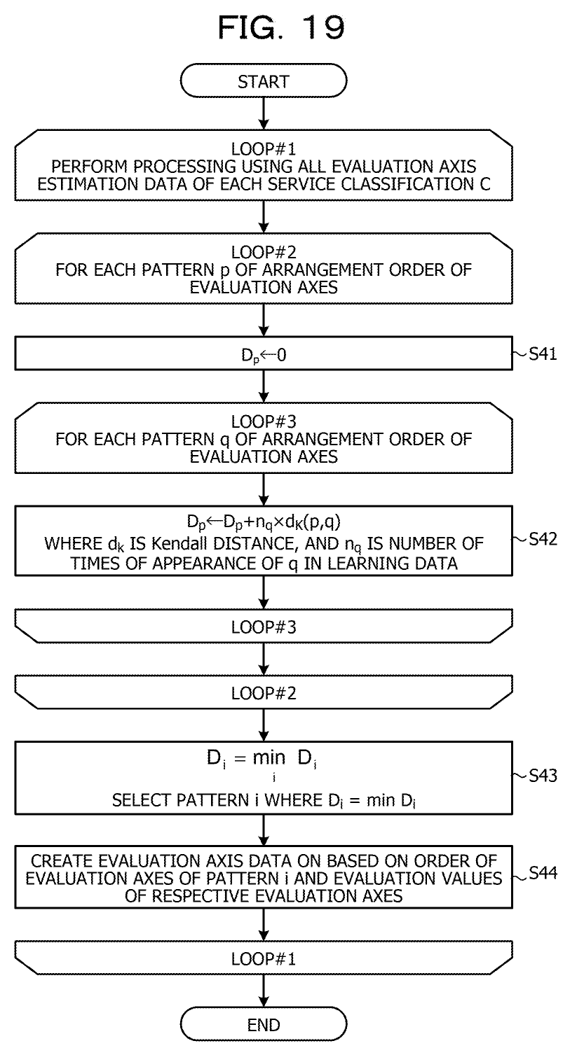

FIG. 19 is a flowchart illustrating a flow of processing by the learning section 26. FIG. 19 represents a case where learning is performed using a plurality of pieces of evaluation axis estimation data created by the evaluation axis estimating section 25. As illustrated in FIG. 19, the learning section 26 performs the processing of a loop #1 using all the evaluation axis estimation data of each service classification C.

In the processing of the loop #1, the learning section 26 performs the processing of a loop #2 and the processing of step S43 and step S44 for each service classification C. In the processing of the loop #2, the learning section 26 initializes Dₚ by zero for each pattern p of arrangement order of the evaluation axes (step S41), and performs the processing of a loop #3. Here, the pattern p is, for example, a permutation of a date, a region, a number of items, and a time period. The pattern p is a permutation included in the evaluation axis estimation data.

Dₚ is a value obtained by adding a value resulting from multiplying a Kendall distance d_{K}(p, q) to another pattern q by a weight n_{q} for all q. The Kendall distance is the number of cases where, in a kth (1≤k≤K) evaluation axis pair of p(k) and q(k) in p and q, p(k) and q(k) are different from each other. n_{q} is the number of appearances of q in the evaluation axis estimation data used for learning.

In the processing of the loop #3, the learning section 26 calculates n_{q}×d_{K}(p, q) for each pattern q of the arrangement order of the evaluation axes, and adds n_{q}×d_{K}(p, q) to Dₚ (step S42).

When ending the processing of the loop #2, the learning section 26 selects a pattern i in which Dᵢ is a minimum among patterns (step S43), and creates evaluation axis data based on order of the evaluation axes of the pattern i and the evaluation values of the respective evaluation axes (step S44).

Thus, the learning section 26 calculates Dₚ for each pattern p by calculating n_{q}×d_{K}(p, q) for each pattern q of the arrangement order of the evaluation axes and adding n_{q}×d_{K}(p, q) to Dₚ, and selects the pattern i in which Dᵢ is a minimum among patterns and creates evaluation axis data. Hence, the learning section 26 may learn the evaluation axis estimation data based on the arrangement order of the evaluation axes.

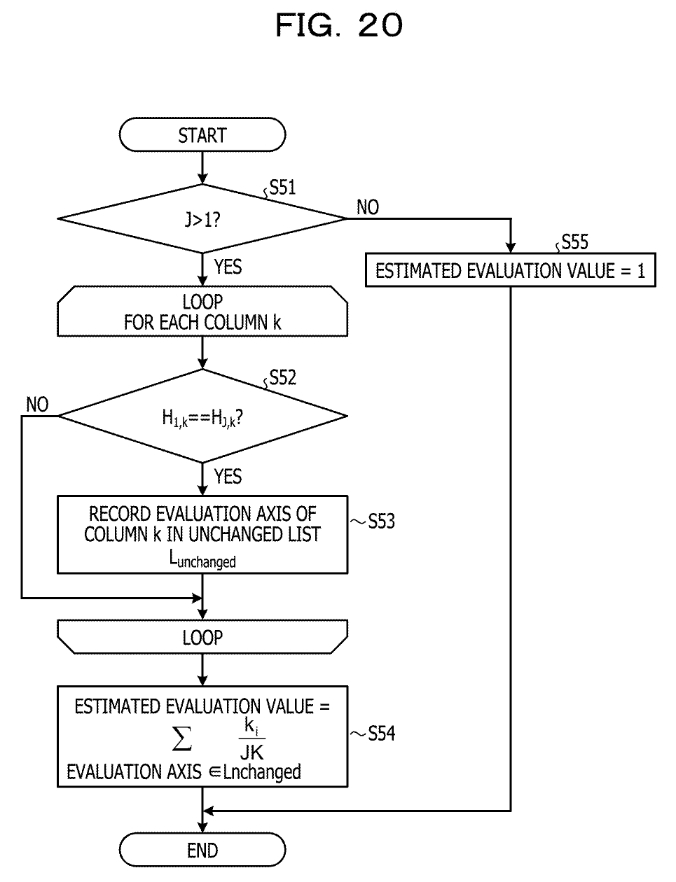

FIG. 20 is a flowchart illustrating a flow of processing by the evaluation estimating section 4. FIG. 20 illustrates a flow of processing in a case where a matching history is evaluated. As illustrated in FIG. 20, the evaluation estimating section 4 determines whether or not J is larger than one (step S51). When J is not larger than one, the evaluation estimating section 4 sets the estimated evaluation value of the matching history at one (step S55).

When J is larger than one, on the other hand, the evaluation estimating section 4 performs, for each column k, processing of determining whether or not H_{1, k} and H_{J, k} are substantially equal to each other (step S52) and recording the evaluation axis of the column k in the unchanged list (step S53) when H_{1, k} and H_{J, k} are substantially equal to each other.

An estimated evaluation value is calculated by adding the evaluation value kᵢ of the evaluation axis included in the unchanged list, and dividing the result by JK (step S54). In this case, unlike the example illustrated in FIG. 3, the evaluation estimating section 4 normalizes the estimated evaluation value by dividing the estimated evaluation value by JK.

The evaluation estimating section 4 may thus evaluate the matching history by adding the evaluation value kᵢ of the evaluation axis included in the unchanged list.

As described above, in the embodiment, the evaluation axis estimating section 25 creates evaluation axis estimation data based on a matching history, and the learning section 26 learns a plurality of pieces of evaluation axis estimation data and creates evaluation axis data. The evaluation estimating section 4 receives a search condition 5b, and outputs a search result 6b based on the evaluation axis data. Hence, the search device 1 may output the search result 6b based on an evaluation axis regarded as important by the user.

In the embodiment, the evaluation estimating section 4 receives a new matching history, and outputs evaluation data 6a based on the evaluation axis data. It is therefore possible to evaluate the matching history based on the evaluation axis regarded as important by the user.

In the embodiment, the learning section 26 learns a plurality of pieces of evaluation axis estimation data for each service classification. The search device 1 may therefore output evaluation data 6a and a search result 6b for each service classification.

In the embodiment, the evaluation axis estimating section 25 calculates an evaluation value based on order in which the condition of an evaluation axis included in a search condition is changed. The evaluation axis regarded as important by the user may therefore be estimated accurately.

In the embodiment, the evaluation axis estimating section 25 further calculates the evaluation value based on a method of changing the condition of the evaluation axis included in the search condition. The evaluation axis regarded as important by the user may therefore be estimated more accurately.

In the embodiment, when the evaluation axis is price, the evaluation axis estimating section 25 calculates the evaluation value based on whether or not the condition of the price is raised. A degree to which the user regards the price as important may therefore be reflected in the evaluation value.

In the embodiment, when an evaluation axis of delivery service is region, the evaluation axis estimating section 25 calculates the evaluation value based on whether the condition of the region is expanded, narrowed, or changed. A degree to which the user regards the region as important may therefore be reflected in the evaluation value.

In the embodiment, the learning section 26 creates a pattern based on order of magnitude of evaluation axes from each piece of evaluation axis estimation data. The learning section 26 uses a Kendall distance between two patterns, identifies a pattern that minimizes a weighted (number of pieces of evaluation axis data corresponding to another pattern) sum of distances to other patterns, and sets evaluation values corresponding to the identified pattern as a result of learning a plurality of pieces of evaluation axis estimation data. The learning section 26 may therefore appropriately learn the order of magnitude of the evaluation axes of the plurality of pieces of evaluation axis estimation data.

It is to be noted that while the search device 1 has been described in the embodiment, a search program including similar functions may be obtained by implementing the configuration possessed by the search device 1 by software. Accordingly, description will be made of a computer that executes the search program.

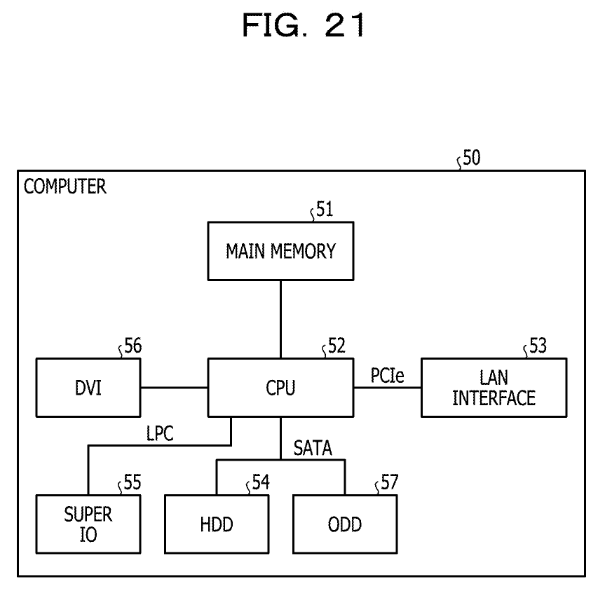

FIG. 21 is a diagram illustrating a hardware configuration of a computer that executes a search program including a plurality of instructions according to an embodiment. As illustrated in FIG. 21, a computer 50 includes a main memory 51, a central processing unit (CPU) 52, a local area network (LAN) interface 53, and a hard disk drive (HDD) 54. The computer 50 also includes a super input output (IO) 55, a digital visual interface (DVI) 56, and an optical disk drive (ODD) 57.

The main memory 51 is a memory that stores a program, an execution in-progress result of the program, and the like. The CPU 52 is a central processing unit reading the program from the main memory 51, and executes the program. The CPU 52 includes a chip set having a memory controller.

The LAN interface 53 is an interface for coupling the computer 50 to another computer via a LAN. The HDD 54 is a disk device that stores a program and data. The super IO 55 is an interface for coupling an input device such as a mouse, a keyboard, and the like. The DVI 56 is an interface for coupling a liquid crystal display device. The ODD 57 is a device that reads and writes a DVD.

The LAN interface 53 is coupled to the CPU 52 by PCI express (PCIe). The HDD 54 and the ODD 57 are coupled to the CPU 52 by serial advanced technology attachment (SATA). The super IO 55 is coupled to the CPU 52 by low pin count (LPC).

The search program to be executed in the computer 50 is stored on a DVD as an example of a recording medium readable by the computer 50, read from the DVD by the ODD 57, and installed on the computer 50. Alternatively, the search program is stored in databases of another computer system coupled via the LAN interface 53 or the like, read from these databases, and installed on the computer 50. The installed search program is stored on the HDD 54, read into the main memory 51, and executed by the CPU 52.

In the embodiment, description has been made of a case where the search device 1 provides information about transportation service. However, the search device 1 may provide information about products or other services.

In the embodiment, description has been made of a case where the evaluation estimating section 4 uses evaluation axis data. However, the evaluation estimating section 4 may use evaluation axis estimation data. For example, the search device 1 does not have to include the learning section 26.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A search device comprising:
a memory; and
a processor coupled to the memory and the processor configured to
calculate a plurality of evaluation values relating to a plurality of items respectively, in accordance with differences between a plurality of search conditions including the plurality of items,
in response to receiving a new search condition, perform a search process based on both the new search condition and the calculated plurality of evaluation values, and
output a result of the search process.

2. The search device according to claim 1, wherein
the plurality of evaluation values are calculated in accordance with input order of the plurality of search conditions.

3. The search device according to claim 1, wherein
the search process includes changing the new search condition into a specific search condition based on the plurality of evaluation values, and performing a search by using the specific search condition.

4. The search device according to claim 1, wherein
the plurality of search conditions is input by a first user.

5. The search device according to claim 1, wherein
the differences include a difference between a first search condition input first among the plurality of search conditions and a second search condition input next.

6. The search device according to claim 1, wherein
the processor is configured to update the plurality of evaluation values in accordance with other differences between other plurality of search conditions.

7. The search device according to claim 1, wherein
the plurality of items includes a price item, and
the plurality of evaluation values are calculated in accordance with a difference expressed by a direction of change in a second value of the price item included in a second search condition input after a first search condition among the plurality of search conditions as compared with a first value of the price item included in the first search condition.

8. The search device according to claim 1, wherein
the plurality of items includes a region item, and
the differences include a difference expressed by at least one of larger, smaller, and different determined by a second value of the region item included in a second search condition input after a first search condition among the plurality of search conditions as compared with a first value of the region item included in the first search condition.

9. A computer-implemented search method comprising:
calculating a plurality of evaluation values relating to a plurality of items respectively, in accordance with differences between a plurality of search conditions including the plurality of items;
in response to receiving a new search condition, performing a search process based on both the new search condition and the calculated plurality of evaluation values; and
outputting a result of the search process.

10. The search method according to claim 9, wherein
the plurality of evaluation values are calculated in accordance with input order of the plurality of search conditions.

11. The search method according to claim 9, wherein
the search process includes changing the new search condition into a specific search condition based on the plurality of evaluation values, and performing a search by using the specific search condition.

12. The search method according to claim 9, wherein
the plurality of search conditions is input by a first user.

13. The search method according to claim 9, wherein
the differences include a difference between a first search condition input first among the plurality of search conditions and a second search condition input next.

14. The search method according to claim 9, further comprising:
updating the plurality of evaluation values in accordance with other differences between other plurality of search conditions.

15. The search method according to claim 9, wherein
the plurality of items includes a price item, and
the plurality of evaluation values are calculated in accordance with a difference expressed by a direction of change in a second value of the price item included in a second search condition input after a first search condition among the plurality of search conditions as compared with a first value of the price item included in the first search condition.

16. The search method according to claim 9, wherein
the plurality of items includes a region item, and
the differences include a difference expressed by at least one of larger, smaller, and different determined by a second value of the region item included in a second search condition input after a first search condition among the plurality of search conditions as compared with a first value of the region item included in the first search condition.

17. A non-transitory computer-readable medium storing instructions executable by one or more computers, the instructions comprising:
one or more instructions for calculating a plurality of evaluation values relating to a plurality of items respectively, in accordance with differences between a plurality of search conditions including the plurality of items;
one or more instructions for, in response to receiving a new search condition, performing a search process based on both the new search condition and the calculated plurality of evaluation values; and
one or more instructions for outputting a result of the search process.
